(19) United States
(12) Patent Application Publication
(10) Pub. No.: US 2016/0244040 A1
(43) Pub. Date: Aug. 25, 2016

(54) INSERT MOLDED ARTICLE, MANUFACTURING METHOD FOR PROTECTIVE COVER HAVING SENSOR HOLDER PART, AND MANUFACTURING METHOD FOR BEARING DEVICE INCLUDING THE PROTECTIVE COVER

(71) Applicant: NAKANISHI METAL WORKS CO., LTD., Osaka-shi (JP)

(72) Inventors: Michiyuki KAMIJI, Osaka-shi (JP); Masayoshi NAKAMURA, Osaka-shi (JP); Toshinari KOMAI, Osaka-shi (JP)

(73) Assignee: NAKANISHI METAL WORKS CO., LTD., Osaka-shi (JP)

(21) Appl. No.: 15/045,593

(22) Filed: Feb. 17, 2016

(30) Foreign Application Priority Data
Feb. 23, 2015 (JP) 2015-032431
Feb. 23, 2015 (JP) 2015-032432
Dec. 11, 2015 (JP) 2015-242102

(51) Int. Cl. B60T 8/32; B29C 45/14; B60T 17/00

(52) U.S. Cl. CPC B60T 8/329; B60T 17/00; B29C 45/14467; B29K 2105/0067

(57) ABSTRACT

There is provided a manufacturing method for a protective cover having a sensor holder part that maintains high reliability over the long term by increasing fixing strength between a cup-shaped main part and a synthetic resin through insert molding.

A cup-shaped main part 1A is positioned at one axial end of a bearing, press-fitted into an outer ring, and has a through hole 6A, in a bottom 6. The manufacturing method includes: a press working step of forming the cup-shaped main part 1A by press working; and an injection molding step of performing injection molding with a nut 10 and the cup-shaped main part 1A as insert articles for attachment of a magnetic sensor A to form a wrap-around portion 8B extending radially outward on an inner side of the bottom 6 through the through hole 6A at a sensor holder part 8 integrated with the nut 10 and the cup-shaped main part 1A.

### TECHNICAL FIELD

The present invention relates to a cup-shaped protective cover that is press-fitted into an outer ring of a bearing to cover a magnetic encoder, more specifically to a protective cover having a sensor holder part holding a magnetic sensor opposed to the magnetic encoder.

### BACKGROUND ART

An antilock brake system widely used in automobiles for efficient and safety braking without wheel lock detects the rotation speeds of wheels by a rotation speed detector (wheel speed sensor), calculates the acceleration and the deceleration and estimates the vehicle speed and the slip ratio by a controller, and drives an actuator to control the brake fluid pressure based on the calculation and estimation results, for example.

Bearing devices including such a rotation speed detector in a rolling bearing for supporting automobile wheels (hub bearing) are also widely used. Such a bearing device may be structured such that a magnetic encoder having N poles and S poles alternately arranged at constant intervals in the circumferential direction is fitted to the inner ring of a bearing, a magnetic sensor for detecting the rotation of the magnetic encoder is attached to the outer ring so as to be opposed to the magnetic encoder, and a protective cover covering the magnetic encoder from the inner side to protect the magnetic encoder is press-fitted into the inner end portion of the outer ring (for example, refer to Patent Document 1).

The protective cover keeps the magnetic encoder from getting hit by pebbles, mud water, or the like and prevents damage to the magnetic encoder. In addition, the protective cover eliminates the need for a seal member on the outer side of the magnetic encoder, which decreases a sliding resistance to reduce rotation torque of the bearing device.

In addition, to eliminate a troublesome work of adjusting the air gap between the magnetic encoder and the magnetic sensor, the protective cover having the sensor holder part for holding the magnetic sensor may be configured such that a boss part composed of a synthetic resin is integrally joined to part of the bottom of a cup-shaped main part (cap) formed in a cup shape by press working on a non-magnetic steel plate, and a nut is integrally joined to the boss part to fix the magnetic sensor (for example, refer to Patent Document 2).

### CITATION LIST

### Patent Literatures

Patent Document 1: JP-A No. 2011-084265

Patent Document 2: JP-A No. 2013-117455

### SUMMARY OF INVENTION

### Technical Problem

In the structure of the protective cover having the sensor holder part as described in Patent Document 2, the boss part composed of a synthetic resin is generally adhered to part of the bottom of the cup-shaped main part (cap). Therefore, even when minute dimples are formed on the adhesion surface of the bottom, the fixing strength between the cup-shaped main part and the boss part may become lower due to long-term use and depending on usage environments, resulting in dropping of the boss part with reduction in reliabilty.

In light of the foregoing circumstances, to solve the problem, an object of the present invention is to provide an insert molded article that maintains high reliability over the long term, a manufacturing method for a protective cover having a sensor holder part, and a manufacturing method for a bearing device including the protective cover, by increasing fixing strength between an insert article and a synthetic resin through insert molding.

### Solution to Problem

To solve the foregoing problem, an insert molded article according to the present invention is an insert molded article in which an insert article and a synthetic resin are integrated, wherein through hole is formed in a joint surface of the insert article relative to the synthetic resin, and the synthetic resin has a wrap-around portion extending radially outward from the joint surface through the through hole (claim 1).

According to this configuration, the synthetic resin of the insert molded article has the wrap-around portion extending radially outward through the through hole of the insert article, whereby the insert article and the synthetic resin are mechanically joined to each other. Accordingly, the fixing strength between the insert article and the synthetic resin becomes high to ensure high reliability of joint between the insert article and the synthetic resin over the long term.

In addition, to solve the foregoing problem, an insert molded article according to the present invention is an insert molded article in which an insert article and a synthetic resin are integrated, wherein the insert article is cup-shaped, the cup shape has a side portion of the bottom smaller in diameter than a side portion of the cup shape to form a step connecting to a bottommost part, the smaller-diameter side portion has a concave or a convex, and the synthetic resin has a step covering portion that covers the step portion (claim 2).

According to this configuration, the step covering portion of the synthetic resin covers the step formed by the bottommost portion and the smaller-diameter side portion of the insert article, and the synthetic resin engages with the concave or the convex formed in the smaller-diameter side portion, whereby the insert article and the synthetic resin are mechanically joined to each other. Accordingly, the fixing strength between the insert article and the synthetic resin becomes high to ensure high reliability of joint between the insert article and the synthetic resin over the long term.

To solve the foregoing problem, a manufacturing method for a protective cover having a sensor holder part according to the present invention is a manufacturing method for a protective cover for use in a bearing device including: an inner ring with an inner ring track surface on an outer periphery; an outer ring with an outer ring track surface on an inner periphery; a bearing having a rolling element rolling between the inner ring track surface and the outer ring track surface; a magnetic encoder that is positioned at one axial end of the bearing, fixed to the inner ring, and has N and S poles alternately arranged at regular intervals in an circumferential direction; and a magnetic sensor that is opposed to the magnetic poles of the magnetic encoder to detect rotation of the magnetic encoder, wherein the protective cover has: a cup-shaped main part that is formed in a cup shape from a non-magnetic steel plate, positioned at the one axial end of the bearing, and press-fitted into the outer ring; and a synthetic resin sensor holder part that is integrally joined to the cup-shaped main part while holding a nut for attaching the magnetic sensor, the cup-shaped main part having a through hole in a bottom, and the manufacturing method includes: a press working step of forming the cup-shaped main part by press working; and an injection molding step of setting the nut and the cup-shaped main part as insert articles into a metal mold, tightening the mold, charging molten plastic into a cavity to perform injection molding to form a wrap-around portion extending radially outward on an inner side of the bottom through the through hole at the sensor holder part integrated with the nut and the cup-shaped main part (claim 3).

By press-fitting the protective cover manufacture by the foregoing manufacturing method into the outer ring of the bearing with the magnetic encoder fixed to the inner ring, the protective cover is axially positioned with respect t the magnetic encoder, and the magnetic sensor is axially positioned and held with respect to the protective cover by the sensor holder part of the protective cover, whereby the air gap between the magnetic sensor and the magnetic encoder is completely adjusted.

This eliminates the need for a troublesome work of adjusting the air gap between the magnetic encoder and the magnetic sensor.

In addition, according to the manufacturing method, by the injection molding with the nut and the cup-shaped main part as insert articles, the wrap-around portion extending radially outward on the inner side of the bottom of the cup-shaped main part through the through hole of the bottom is formed at the synthetic resin sensor holder part integrated with the nut and the cup-shaped main part.

Therefore, in the protective cover manufactured by the foregoing manufacturing method, the cup-shaped main part and the sensor holder part are mechanically joined to each other. This increases the fixing strength between the cup-shaped main part and the sensor holder part to ensure high reliability of joint between the cup-shaped main part and the sensor holder part over the long term.

It is preferred that the manufacturing method includes at least one of a vulcanization and adhesion step of vulcanizing and adhering an endless seal body to a periphery of the through hole in the cup-shaped main part and an adhesive application step of applying a thermoset adhesive to the periphery (claim 4).

According to the manufacturing method, even when the through hole is formed in the bottom of the cup-shaped main part, the vulcanization and adhesion step or the adhesive application step allows the seal body or the adhesive layer on the periphery of the through hole intervenes between the cup-shaped main part and the sensor holder part to retain airtightness of the protective cover.

It is also preferred that the bottom of the cup-shaped main part has a disc portion as a bottommost portion, a cylindrical portion extending axially from an outer edge of the disc portion, and an annular portion extending radially outward from an axial end edge of the cylindrical portion, and the sensor holder part has a portion covering the disc portion and the cylindrical portion (claim 5).

According to the manufacturing method, the bottom of the cup-shaped main part formed at the press working step has the disc portion as an bottommost portion, the cylindrical portion extending axially from the outer edge of the disc portion, and the annular portion extending radially outward from the axial end edge of the cylindrical portion, and the sensor holder part formed at the injection molding step has the portion covering the step formed by the disc portion with the through hole of the cup-shaped main part and the cylindrical portion extending axially from the outer edge of the disc portion. Accordingly the protective cover manufactured by the manufacturing method has the effect of retaining some degree of airtightness even without having to provide the vulcanization and adhesion step or the adhesive application step, thereby achieving reduction in manufacturing costs.

To solve the foregoing problem, a manufacturing method for a protective cover having a sensor holder part according to the present invention is a manufacturing method for a protective cover for use in a bearing device including: an inner ring with an inner ring track surface on an outer periphery; an outer ring with an outer ring track surface on an inner periphery; a bearing having a rolling element rolling between the inner ring track surface and the outer ring track surface; a magnetic encoder that is positioned at one axial end of the bearing, fixed to the inner ring, and has N and S poles alternately arranged at regular intervals in an circumferential direction; and a magnetic sensor that is opposed to the magnetic poles of the magnetic encoder to detect rotation of the magnetic encoder, wherein the protective cover has: a cup-shaped main part that is formed in a cup shape from a non-magnetic steel plate, positioned at the one axial end of the bearing, and press-fitted into the outer ring; and a synthetic resin sensor holder part that is integrally joined to the cup-shaped main part while holding a nut for attaching the magnetic sensor, the bottom of the cup-shaped main part has a disc portion as a bottommost portion, a cylindrical portion extending axially from an outer edge of the disc portion, and an annular portion extending radially outward from an axial end edge of the cylindrical portion, the cylindrical portion having a concave or a convex, and the manufacturing method includes: a press working step of forming the cup-shaped main part by press working; and a injection molding step of setting the nut and the cup-shaped main part as insert articles into a metal mold, tightening the mold, charging molten plastic into a cavity to perform injection molding to form a step covering portion covering a step formed by the disc portion and the cylindrical portion at the sensor holder part integrated with the nut and the cup-shaped main part (claim 6).

By press-fitting the protective cover manufactured by the foregoing manufacturing method into the outer ring of the bearing with the magnetic encoder fixed to the inner ring, the protective cover is axially positioned with respect to the magnetic encoder, and the magnetic sensor is axially positioned and held with respect to the protective cover by the sensor holder part of the protective cover, whereby the air gap between the magnetic sensor and the magnetic encoder is completely adjusted.

This eliminates the need for a troublesome work of adjusting the air gap between the magnetic encoder and the magnetic sensor.

In addition, according the manufacturing method, by the injection molding with the nut and the cup-shaped main part as insert articles, the step covering portion covering the step formed by the disc portion and the cylindrical portion of the cup-shaped main part is formed at the synthetic resin sensor holder part integrated with the nut and the cup-shaped main part. The synthetic resin of the sensor holder part engages with the concave or the convex formed in the cylindrical portion of the cup-shaped main part.

Therefore, in the protective cover manufactured by the foregoing manufacturing method, the cup-shaped main part and the sensor holder part are mechanically joined to each other. This increases the fixing strength between the cup-shaped main part and the sensor holder part to ensure high reliability of joint between the cup-shaped main part and the sensor holder part over the long term.

Further, a manufacturing method a bearing device according to the present invention is a manufacturing method for a bearing device including: an inner ring with an inner ring track surface on an outer periphery; an outer ring with an outer ring track surface on an inner periphery; a bearing having a rolling element rolling between the inner ring track surface and the outer ring track surface; a magnetic encoder that is positioned at one axial end of the bearing, fixed to the inner ring, and has N and S poles alternately arranged at regular intervals in an circumferential direction; and a magnetic sensor that is opposed to the magnetic poles of the magnetic encoder to detect rotation of the magnetic encoder, wherein the manufacturing method includes a step of press-fitting the protective cover manufactured by the manufacturing method for the protective cover having the sensor holder part into the outer ring (claim 7).

### Advantageous Effects of Invention

According to the insert molded article, the manufacturing method for a protective cover having a sensor holder part, and the manufacturing method for a bearing device including the protective cover according to the present invention described above, the synthetic resin (sensor holder part) of the insert molded article (protective cover) and the insert article (cup-shaped main part) are mechanically joined to each other. Accordingly, the fixing strength between the insert article and the synthetic resin becomes large to produce the significantly advantageous effect of ensuring high reliability of joint between the insert article and the synthetic resin over the long term.

### BRIEF DESCRIPTION OF DRAWINGS

FIG. 1 is a partial vertical cross-sectional view of a bearing device including a protective cover with a sensor holder part according to a first embodiment of the present invention;

FIG. 2 is an enlarged perspective vertical cross-sectional view of main components of the protective cover with the sensor holder part according to the first embodiment of the present invention to which a magnetic sensor is attached;

FIG. 3 is a vertical cross-sectional view of an example of an injection metal mold;

FIG. 4 is a partial vertical cross-sectional view of a bearing device including a protective cover with a sensor holder part according to a second embodiment of the present invention;

FIG. 5 is an enlarged perspective vertical cross-sectional view of main components of the protective cover with the sensor holder part according to the second embodiment of the present invention to which a magnetic sensor is attached;

FIG. 6 is a partial vertical cross-sectional view of a bearing device including a protective cover with a sensor holder part according to a third embodiment of the present invention;

FIG. 7 is an enlarged perspective vertical cross-sectional view of main components of the protective cover with the sensor holder part according to the third embodiment of the present invention to which a magnetic sensor is attached;

FIG. 8 is a partial vertical cross-sectional view of the same; and

FIG. 9 is a vertical cross-sectional view of an example of an injection metal mold.

### DESCRIPTION OF EMBODIMENTS

Next, embodiments of the present invention will be described in detail with reference to the accompanying drawings. However, the present invention is not limited to the embodiments illustrated in the accompanying drawings but includes all of embodiments satisfying the requirements described in the claims.

### First Embodiment

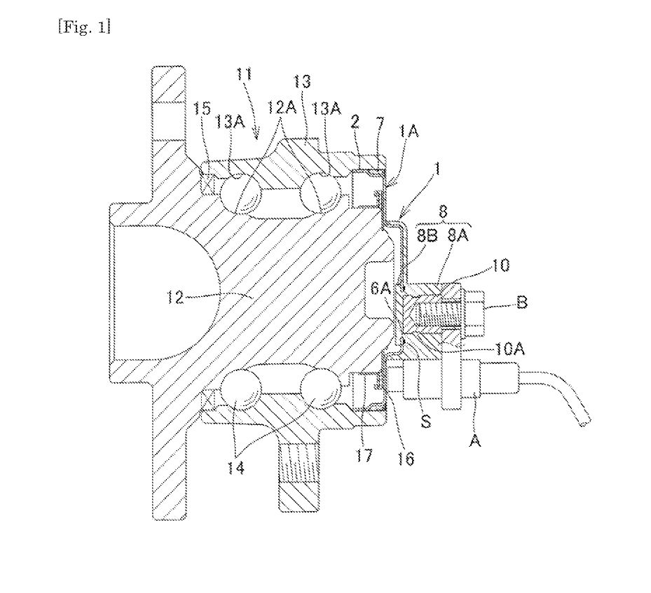

A bearing device 11 according to a first embodiment of the present invention illustrated in the partial vertical cross-sectional view of FIG. 1 includes a magnetic encoder 16, a protective cover 1, and a magnetic sensor A arranged at one axial end of the bearing, and a seal member 15 arranged at the other axial end of the bearing, and others, in addition to a bearing with an inner ring 12 rotating relative to an outer ring 13.

The bearing has the inner ring 12 with an inner ring track surface 12A on the outer periphery the outer ring 13 with an outer ring track surface 13A on the inner periphery, and rolling elements 14, 14, . . . rolling between the inner ring track surface 12A and the outer ring track surface 13A, and others.

The magnetic encoder 16 has N and S poles alternately arranged at regular intervals in the circumferential direction, and is fixed to the inner ring 12 by a support member 17 positioned at the one axial end of the bearing.

The protective cover 1 is attached to the outer ring 13 to seal the one axial end of the bearing and has a sensor holder part 8 holding the magnetic sensor A.

The magnetic sensor A attached to the sensor holder part 8 of the protective cover 1 is opposed to the magnetic encoder 16 to detect the rotation of the magnetic encoder 16.

At the bearing device 11 illustrated in FIG. 1, a cup-shaped main part 1A of the protective cover 1 is press-fitted into the outer ring 13 of the bearing in which the magnetic encoder 16 is fixed to the inner ring 12, whereby the protective cover 1 is axially positioned with respect to the magnetic encoder 16.

The magnetic sensor A is axially positioned and held with respect to the protective cover 1 by the sensor holder part 8 of the protective cover 1, and an air gap between the magnetic sensor A and the magnetic encoder 16 is completely adjusted.

This eliminates a troublesome work of adjusting the air gap between the magnetic encoder 16 and the magnetic sensor A.

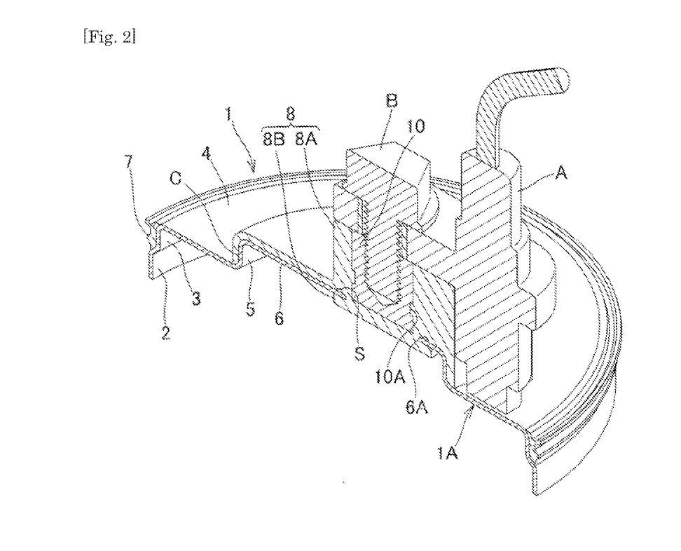

As illustrated in the partial vertical cross-sectional view of FIG. 1 and the enlarged perspective vertical cross-sectional view of main components of FIG. 2, the protective cover 1 according to the first embodiment of the present invention has the cup-shaped main part 1A formed in a cup shape by press working of a non-magnetic steel plate and the synthetic resin sensor holder part 8 that is integrally joined to the cup-shaped main part 1A while holding a nut 10 to which an attachment bolt B for attachment of the magnetic sensor A is screwed.

The protective cover 1 is an insert molded article, and the cup-shaped main part 1A and the nut 10 are insert articles.

The cup-shaped main part 1A is composed of a first cylindrical portion 2 press-fitted into the outer ring 13, a second cylindrical portion 3 that is smaller in diameter than the first cylindrical portion 2, connects to an end edge of the first cylindrical portion 2, and has an outer peripheral surface to which a seal body 7 is vulcanized and adhered, an annular portion 4 that connects to an end edge of the second cylindrical portion and extends radially inward, a third cylindrical portion 5 that connects to an inner-side end edge of the annular portion 4 and extends axially, and a disc portion 6 connecting to an end edge of the third cylindrical portion 5. The disc portion 6 (the bottom of the cup-shaped main part 1A) has a through hole 6A.

The bottom of the cup-shaped main part 1A has the disc portion 6 as a bottommost portion, a third cylindrical portion 5 extending axially from an outer edge of the disc portion 6, the annular portion 4 extending radially outward from an axial end edge of the third cylindrical portion 5, and a step C (see FIG. 2) formed by the disc portion 6 and the third cylindrical portion 5 extending axially from the outer edge of the disc portion 6.

The sensor holder part 8 integrated with the cup-shaped main part 1A has a base portion 8A holding the nut 10 and a wrap-around portion 8B that extends radially outward at the inner side of the cup-shaped main part 1A through the through hole 6A of the disc portion 6. The base portion 8A has a portion covering the disc portion 6 and the third cylindrical portion 5.

An endless seal body S intervenes between the cup-shaped main part 1A and the sensor holder part 8 around the through hole 6A.

The seal bodies 7 and S are elastic bodies such as synthetic rubbers and can be formed of one of rubbers such as nitrile rubber (NBR), hydrogenated nitrite rubber (HNBR), acrylic rubber (ACM), ethylene-acrylic rubber (AEM), fluorine rubber (FKM, FPM), and silicone rubber (VMQ) or an appropriate blend of two or more of these rubbers.

Next, a manufacturing method for the protective cover 1 having the sensor holder part 8 will be described.

### <Press Working Step>

At a press working step, the cup-shaped main part 1A constituting the protective cover 1 is formed from an austenitic stainless-steel plate material by press working, for example.

### <Vulcanization and Adhesion Step>

At a vulcanization and adhesion step, the seal body 7 is vulcanized and adhered to the outer peripheral surface of the second cylindrical portion 3 of the cup-shaped main part 1A shaped at the press working step, and the endless (for example, annular) seal body S is vulcanized and adhered around the through hole 6A of the disc portion 6.

Alternatively, at an adhesive application step of applying a thermoset adhesive around the through hole 6A of the disc portion 6, instead of the seal body S, may be performed, or both the vulcanization and adhesion step of vulcanizing and adhering the seal body S and the adhesive application step of applying the thermoset adhesive may be performed.

### <Injection Molding Step>

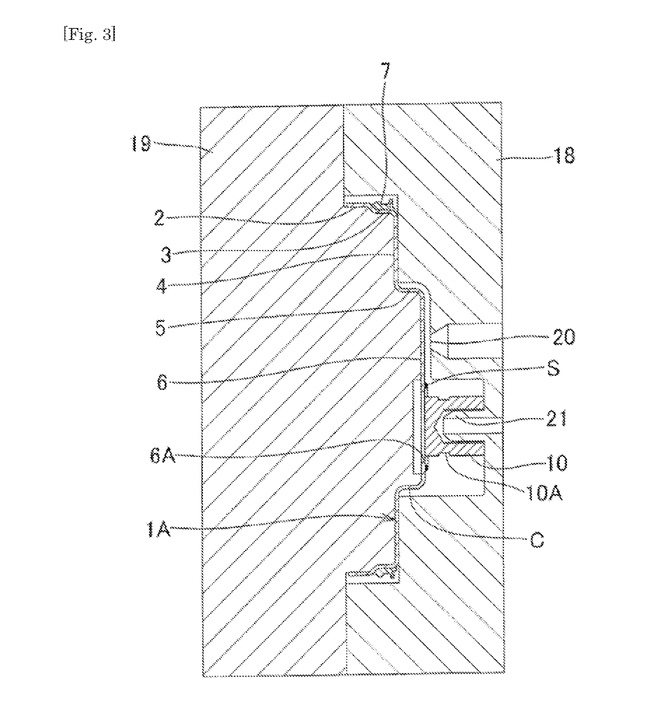

In an injection mold illustrated in the vertical cross-sectional view of FIG. 3, first, the nut 10 as an insert article is set on a support shaft 21 of a fixed mold 18.

The cup-shaped main part 1A as an insert article having undergone the press working step and the vulcanization and adhesion step is set in a movable mold 19.

Next, while the fixed mold 18 and the movable mold 19 are mounted on an injection molding machine and are tightened, molten plastic is injected through a sprue and charged from a gate 20 into a cavity between the fixed mold 18 and the movable mold 19.

Next, the molten plastic is cooled and solidified, and then the movable mold 19 is opened to remove the insert molded article.

In the protective cover 1 having undergone the injection molding step as described above (see FIGS. 1 and 2),the synthetic resin is entered into a circumferential groove 10A of the nut 10 to retain the nut 10, and a wrap-around portion 8B in which the synthetic resin wraps around the disc portion 6 radially outward through the through hole 6A is formed. Accordingly, the cup-shaped main part 1A and the sensor holder part 8 are mechanically joined to each other.

One or both of the seal body S and the adhesive layer intervene between the cup-shaped main part 1A and the sensor holder part 8 around the through hole 6A of the disc portion 6, thereby to keep the airtightness of the protective cover 1.

The base portion 8A of the sensor holder part 8 has the portion covering the disc portion 6 and the third cylindrical portion 5 (the step C illustrated in FIG. 2) to produce the effect of keeping airtightness to some degree without the seal body S and the adhesive layer. Accordingly, the seal body S or the adhesive layer may not be provided depending on the required specifications.

### Second Embodiment

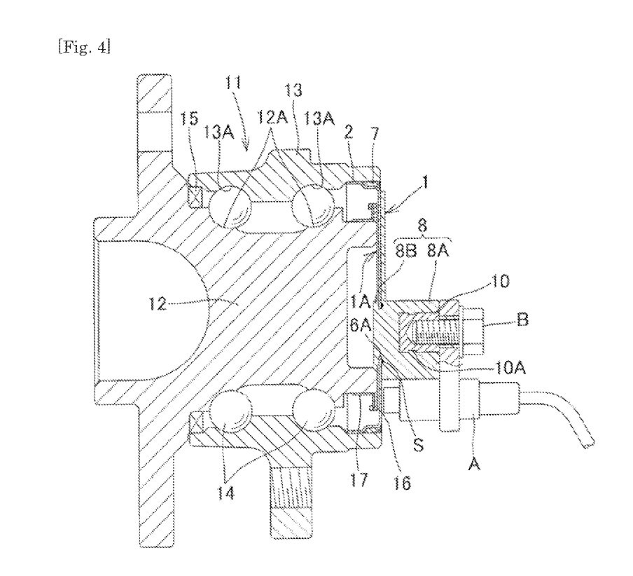

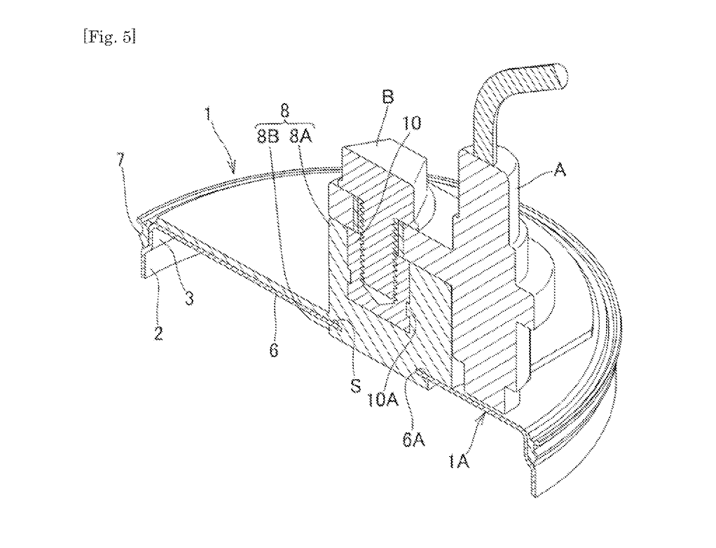

In a bearing device 11 and a protective cover 1 according to a second embodiment of the present invention illustrated in the partial vertical cross-sectional view of FIG. 4 and the protective cover 1 according to the second embodiment of the present invention illustrated in the enlarged perspective vertical cross-sectional view of main components of FIG. 5, the components with the same reference signs as those in the first embodiment illustrated in FIGS. 1 and 2 are the components identical or equivalent to the components in the first embodiment, and descriptions thereof will be omitted.

A cup-shaped main part 1A of the protective cover 1 in the second embodiment is composed of a first cylindrical portion 2 press-fitted into the outer ring 13, a second cylindrical portion 3 that is smaller in diameter than the first cylindrical portion 2, connects to an end edge of the first cylindrical portion 2, and has an outer peripheral surface to which a seal body 7 is vulcanized and adhered, and a disc portion 6 connecting to an end edge of the second cylindrical portion 3. The disc portion 6 (the bottom of the cup-shaped main part 1A) has a through hole 6A.

Accordingly, the cup-shaped main part 1A in the second embodiment does not have the step C in the first embodiment illustrated in FIG. 2, which allows simplification of the processing process of the cup-shaped main part 1A with reduction in manufacturing costs of the protective cover 1.

According to the configuration of the protective cover 1 in the first and second embodiments, the synthetic resin sensor holder part 8 of the protective cover 1 as an insert molded article has the wrap-around portion 8B extending radially outward through the through hole 6A of the bottom of the cup-shaped main part 1A as an insert article, whereby the cup-shaped main part 1A and the sensor holder part 8 are mechanically joined to each other.

Accordingly, the fixing strength between the cup-shaped main part 1A and the sensor holder part 8 becomes large to produce the significantly advantageous effect of ensuring high reliability of joint between the cup-shaped main part 1A and the sensor holder part 8 over the long term.

The technique for mechanically joining the cup-shaped main part 1A and the sensor holder part 8 in the protective cover 1 as described above is also applicable to insert molded articles other than the protective cover 1 in which the insert article and the synthetic resin are integrated by insert molding.

Specifically, a through hole is formed in a joining surface between an insert article and a synthetic resin, and a wrap-around portion extending radially outward from the joining surface through the through hole is formed in the synthetic resin.

### Third Embodiment

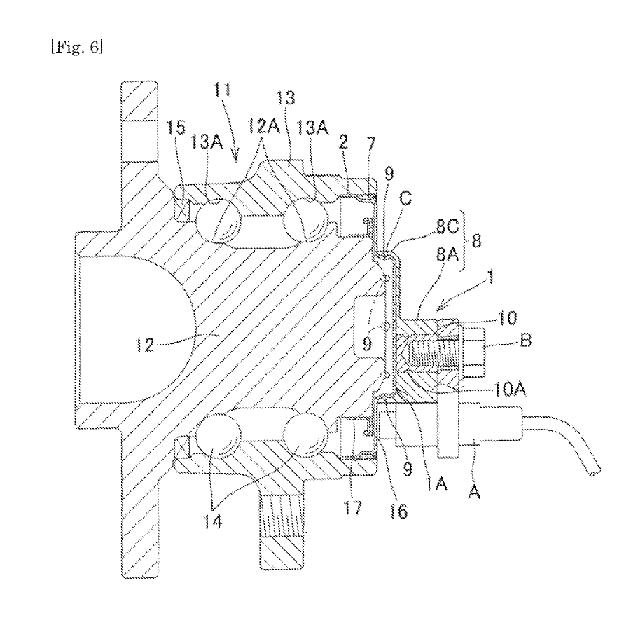

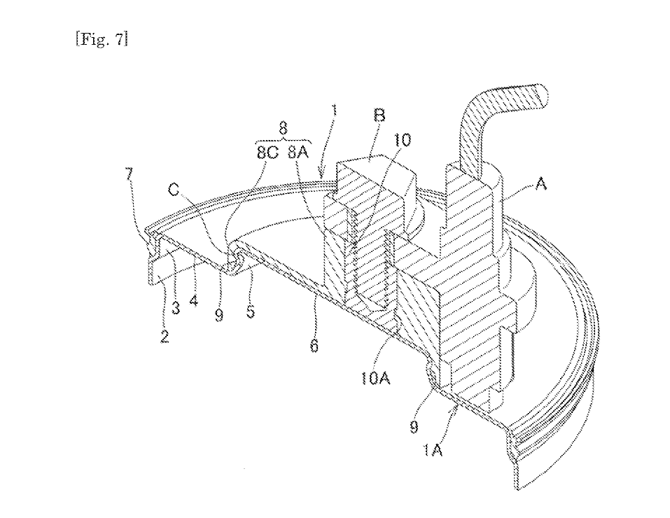

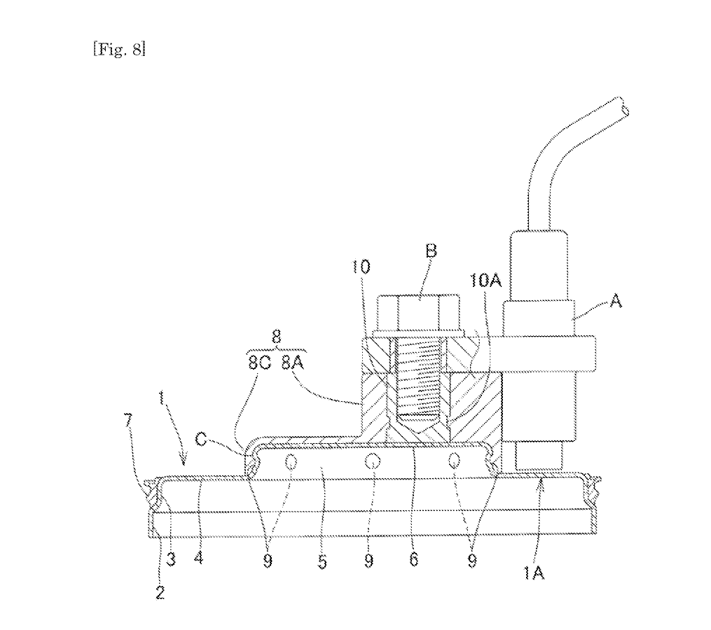

In a bearing device 11 and a protective cover 1 according to a third embodiment of the present invention illustrated in the partial vertical cross-sectional view of FIG. 6 and the protective cover 1 according to the third embodiment of the present invention illustrated in the enlarged perspective vertical cross-sectional view of main components of FIG. 7 and the partial vertical cross-sectional view of FIG. 8, the components with the same reference signs as those in the first embodiment illustrated in FIGS. 1 and 2 are the components identical or equivalent to the components in the first embodiment, and descriptions thereof will be omitted.

The cup-shaped main part 1A of the protective cover 1 in the third embodiment has concaves 9, 9, . . . formed in the outer peripheral surface of the third cylindrical portion 5 by pressing the third cylindrical portion 5 with a punch or the like from the outside and thus does not have the through hole 6A in the first embodiment.

The sensor holder part 8 has the base portion 8A holding the nut 10 and a step covering portion 8C covering the step C formed by the disc portion 6 and the third cylindrical portion 5. The synthetic resin of the sensor holder part 8 is entered into the concaves 9, 9, . . . to integrate the sensor holder part 8 with the cup-shaped main part 1A.

Next, a manufacturing method for the protective cover 1 having the sensor holder part 8 will be described.

### <Press Working Step>

At a press working step, the cup-shaped main part 1A constituting the protective cover 1 is formed from an austenitic stainless-steel plate material by press working, for example.

### <Vulcanization and Adhesion Step>

At a vulcanization and adhesion step, the seal body 7 is vulcanized and adhered to the outer peripheral surface of the second cylindrical portion 3 of the cup-shaped main part 1A shaped at the press working step.

Alternatively, an adhesive application step of applying a thermoset adhesive to a joint surface of the cup-shaped main part 1A relative to the synthetic resin may be performed to improve the joint strength between the cup-shaped main part 1A and the synthetic resin.

### <Injection Molding Step>

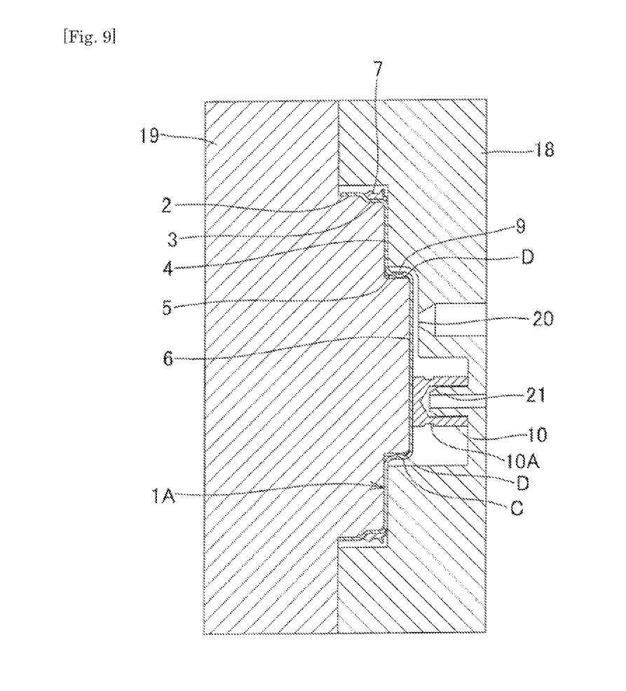

In an injection mold illustrated in the vertical cross-sectional view of FIG. 9, first, the nut 10 as an insert article is set on a support shaft 21 of a fixed mold 18.

The cup-shaped main part 1A as an insert article having undergone the press working step and the vulcanization and adhesion step is set in a movable mold 19.

Next, while the fixed mold 18 and the movable mold 19 are mounted on an injection molding machine and are tightened, molten plastic is injected through a sprue and charged from a gate 20 into a cavity between the fixed mold 18 and the movable mold 19.

Next, the molten plastic is cooled and solidified, and then the movable mold 19 is opened to remove the insert molded article.

In the protective cover 1 having undergone the injection molding step as described above (see FIGS. 6 to 8), the synthetic resin is entered into a circumferential groove 10A of the nut 10 to retain the nut 10. In addition, the sensor holder part 8 has the step covering portion 8C covering the step C of the cup-shaped main part 1A, and the synthetic resin of the sensor holder part 8 is entered into the concaves 9, 9, . . . formed in the outer peripheral surface of the third cylindrical portion 5 of the cup-shaped main part 1A. Accordingly, the cup-shaped main part 1A and the sensor holder part 8 are mechanically joined to each other.

As illustrated in FIGS. 6 to 8, the concaves 9. 9, . . . are formed in the outer peripheral surface of the third cylindrical portion 5 to produce convexes in the inner peripheral surface of the third cylindrical portion 5. Accordingly, even in the presence of an undercut portion, the movable mold 19 illustrated in FIG. 9 has smaller-diameter portions D, D, . . . at positions corresponding to the convexes, which facilitates setting of the cup-shaped main part 1A to the movable mold 19 and removal of the protective cover 1 from the movable mold 19.

According to the configuration of the protective cover 1 in the third embodiment, the synthetic resin sensor holder part 8 covers the step C formed by the disc portion 6 as a bottommost portion of the cup-shaped main part 1A as an insert article and the third cylindrical portion 5 extending axially from the outer edge of the disc portion 6, and the sensor holder part 8 engages with the concaves 9, 9, . . . formed in the third cylindrical portion 5, whereby the cup-shaped main part 1A and the sensor holder part 8 are mechanically joined to each other.

Accordingly the fixing strength between the cup-shaped main part 1A and the sensor holder part 8 becomes large to ensure high reliability of joint between the cup-shaped main part 1A and the sensor holder part 8 over the long term.

In the case described above, the concaves 9, 9, . . . are formed in the outer peripheral surface of the third cylindrical portion 5 as a smaller-diameter side portion of the cup-shaped main part 1A. Alternatively, convexes may be formed in the outer peripheral surface of the third cylindrical portion 5. In this case, there is no need for the diameter-reduced portions D, D, . . . in the movable mold 19 illustrated in FIG. 9.

The technique for mechanically joining the cup-shaped main part 1A and the sensor holder part 8 in the protective cover 1 as described above is also applicable to insert molded articles other than the protective cover 1 in which the insert article and the synthetic resin are integrated by insert molding.

Specifically, an insert article is formed in a cup shape, the bottom of the cup shape is provided with a step having a side portion that is smaller in diameter than a side portion of the cup shape and connects to the bottommost portion, concaves or convexes are formed in the smaller-diameter side portion, and the synthetic resin has a portion covering the step (the bottommost portion and the smaller-diameter side portion).

### REFERENCE SIGNS LIST

1 Protective cover (insert molded article)
1A Cup-shaped main part (insert article)
2 First cylindrical portion
3 Second cylindrical portion
4 Annular portion
5 Third cylindrical portion (smaller-diameter side portion)
6 Disc portion (bottommost portion)
6A Through hole
7 Seal body
8 Sensor holder part (synthetic resin)
8A Base portion
8B Wrap-around portion
8C Step covering portion
9 Concave
10 Nut (insert article)
10A Circumferential groove
11 Bearing device
12 Inner ring
12A Inner ring track surface
13 Outer ring
13A Outer ring track surface
14 Rolling element
15 Seal member
16 Magnetic encoder
17 Support member
18 Fixed mold
19 Movable mold
20 Gate
21 Support shaft
A Magnetic sensor
B Attachment bolt
C Step
D Diameter-reduced portion
S Seal body

1. An insert molded article in which an insert article and a synthetic resin are integrated, wherein
a through hole is formed in a joint surface of the insert article relative to the synthetic resin, and
the synthetic resin has a wrap-around portion extending radially outward from the joint surface through the through hole.

2. An insert molded article in which an insert article and a synthetic resin are integrated, wherein
the insert article is formed in a cup shape,
the cup shape has a side portion of the bottom smaller in diameter than a side portion of the cup shape to form a step connecting to a bottommost part,
the side portion with the smaller-diameter has a concave or a convex, and
the synthetic resin has a step covering portion that covers the step portion.

3. A manufacturing method for a protective cover having a sensor holder part for use in a bearing device including: an inner ring with an inner ring track surface on an outer periphery; an outer ring with an outer ring track surface on an inner periphery; a bearing having a rolling element rolling between the inner ring track surface and the outer ring track surface; a magnetic encoder that is positioned at one axial end of the bearing fixed to the inner ring, and has N and S poles alternately arranged at regular intervals in an circumferential direction; and a magnetic sensor that is opposed to the magnetic poles of the magnetic encoder to detect rotation of the magnetic encoder, wherein
the protective cover has:
a cup-shaped main part that is formed in a cup shape from a non-magnetic steel plate, positioned at the one axial end of the bearing, and press-fitted into the outer ring; and
a synthetic resin sensor holder part that is integrally joined to the cup-shaped main part while holding a nut for attaching the magnetic sensor, the cup-shaped main part having a through hole in a bottom, and
the manufacturing method comprises:
a press working step of forming the cup-shaped main part by press working; and
an injection molding step of setting the nut and the cup-shaped main part as insert articles into a metal mold, tightening the mold, charging molten plastic into a cavity to perform injection molding to form a wrap-around portion extending radially outward on an inner side of the bottom through the through hole at the sensor holder part integrated with the nut and the cup-shaped main part.

4. The manufacturing method for a protective cover having a sensor holder part according to claim 3, comprising at least one of a vulcanization and adhesion step of vulcanizing and adhering an endless seal body to a periphery of the through hole in the cup-shaped main part, and an adhesive application step of applying a thermoset adhesive to the periphery.

5. The manufacturing method for a protective cover having a sensor holder part according to claim 3, wherein
the bottom of the cup-shaped main part has a disc portion as a bottommost portion, a cylindrical portion extending axially from an outer edge of the disc portion, and an annular portion extending radially outward from an axial end edge of the cylindrical portion, and
the sensor holder part has a portion covering the disc portion and the cylindrical portion.

6. A manufacturing method for a protective cover having a sensor holder part for use in a bearing device including; an inner ring with an inner ring track surface on an outer periphery; an outer ring with an outer ring track surface on an inner periphery; a bearing having a rolling element rolling between the inner ring track surface and the outer ring track surface; a magnetic encoder that is positioned at one axial end of the bearing, fixed to the inner ring, and has N and S poles alternately arranged at regular intervals in an circumferential direction; and a magnetic sensor that is opposed to the magnetic poles of the magnetic encoder to detect rotation of the magnetic encoder, wherein
the protective cover has:
a cup-shaped main part that is formed in a cup shape from a non-magnetic steel plate, positioned at the one axial end of the bearing, and press-fitted into the outer ring; and
a synthetic resin sensor holder part that is integrally joined to the cup-shaped main part while holding a nut for attaching the magnetic sensor,
the bottom of the cup-shaped main part has a disc portion as a bottommost portion, a cylindrical portion extending axially from an outer edge of the disc portion, and an annular portion extending radially outward from an axial end edge of the cylindrical portion, the cylindrical portion having a concave or a convex, and
the manufacturing method comprises:
a press working step of forming the cup-shaped main part by press working; and
an injection molding step of setting the nut and the cup-shaped main part as insert articles into a metal mold, tightening the mold, charging molten plastic into a cavity to perform injection molding to form a step covering portion covering a step formed by the disc portion and the cylindrical portion at the sensor holder part integrated with the nut and the cup-shaped main part.

7. A manufacturing method for a bearing device including: an inner ring with an inner ring track surface on an outer periphery; an outer ring with an outer ring track surface on an inner periphery; a bearing having a rolling element rolling between the inner ring track surface and the outer ring track surface; a magnetic encoder that is positioned at one axial end of the bearing, fixed to the inner ring, and has N and S poles alternately arranged at regular intervals in an circumferential direction; and a magnetic sensor that is opposed to the magnetic poles of the magnetic encoder to detect rotation of the magnetic encoder,
the manufacturing method comprising a step of press-fitting the protective cover manufactured by the manufacturing method for the protective cover having the sensor holder part according to any one of claims 3 to 6 into the outer ring.
